(19) United States
(12) Patent Application Publication
(10) Pub. No.: US 2011/0265301 A1
(43) Pub. Date: Nov. 3, 2011

(54) VARIABLE VEHICLE BODY FIXED FRAMER AND METHOD

(75) Inventor: Velibor Kilibarda, Birmingham, MI (US)

(73) Assignee: COMAU, INC., Southfield, MI (US)

(21) Appl. No.: 13/097,134

(22) Filed: Apr. 29, 2011

Related U.S. Application Data
(60) Provisional application No. 61/329,918, filed on Apr. 30, 2010.

(51) Int. Cl. B23Q 17/00; B23P 21/00

(52) U.S. Cl. 29/407.01; 29/705

(57) ABSTRACT

An vehicle body framing apparatus and method for use in assembling vehicle body structures of varying vehicle types in a framing station positioned along an assembly line. The apparatus includes an overhead bridge frame that is connected to two pairs of vertical pillars positioned at a build station. One pair of the pillars is moveable to accommodate different lengths of vehicle bodies. The spaced pillars and overhead bridge provide substantially unobstructed access openings to the body sides of the vehicle to increase efficiency and quality of build. The device and method may include a bridge frame storage and transport system for remotely storing the different bridge frames not in use and then transporting a selected bridge frame to the build station for use.

### CROSS REFERENCE TO RELATED APPLICATIONS

This application claims priority benefit to U.S. Provisional Patent Application Ser. No. 61/329,918 filed Apr. 30, 2010, the entire contents of which is incorporated herein by reference.

### FIELD OF INVENTION

This invention generally relates to motor vehicle body assembly systems.

### BACKGROUND OF THE INVENTION

Increasing emphasis is placed on the accuracy and precision in manufacturing and assembly process, particularly in the field of passenger vehicles. Demand for higher volumes of vehicles and efficient manufacturing and assembly of such vehicles has also increased further straining the objectives of accuracy, precision and quality of the end product. Further demands have been placed on manufacturers to accommodate the changing demands for the type of vehicles to be built in a single manufacturing facility. Manufacturers need equipment and processes that allow to quickly switch between vehicle types or models that are built without shutting down assembly lines, changing tooling, fixtures, robots and the inventory of parts to support the varying builds.

In the assembly of passenger vehicles, the building block is the skeletal body, still often made of formed sheet steel components and subassemblies. Modern assembly plants require many sequential build stations positioned along a progressive assembly line. Typically, however, a single or primary body framing station is used to assemble the foundational skeletal structure components and establish the critical geometry for the body which all other components are subsequently attached. At this critical framing station, it is essential that the vehicle body be accurately and precisely positioned so the welding robots and other assembly equipment can accurately and precisely position and mount the components or subassemblies at this station.

Traditional body framing systems have used rigid, heavy side gate structures which are positioned on either side of an assembly line and are moved toward the assembly line and fixed in place. These side gate structures were often a lattice or truss-like structure having vertical, horizontal and angled cross-braces to form a rigid structure and also support fixtures, tooling and other devices needed to accurately position the progressively-built body structure and connect, typically through spot welding, additional components and subassemblies at the primary geometry framing stations within the assembly line. These side gate frames often obstructed access to many areas along the vehicle body sides and above the vehicle to conduct the critical geometry processes at the primary framing station. For example, robots and spot welding equipment would have to be programmed or articulated around the side gate frames to reach the desired portion of the vehicle to be spot welded. Where manual assembly operations were needed, the large and heavy side gates limited access to the vehicle body and logistically took up much space in the immediate area around the vehicle. This was disadvantageous in numerous ways and created many challenges for a fast and efficient assembly process to construct the vehicle bodies.

In prior body and geometry framing processes, the vehicle skeletal underbody would be presented on a pallet or other transport device and positioned in the framing station. The skeletal vehicle body sides would be positioned on the heavy side gate fixtures and moved into position in the framer. Skeletal components which are positioned across the vehicle, for example the dash panel, cowl panel, back panel and package trays are positioned on fixtures and moved into respective positions in the framer. Sequentially, the separate components and subassemblies are welded or otherwise connected to form the skeletal body structure and establish the vehicle body geometry.

It would be advantageous to improve upon prior systems for framing a vehicle body structure which is essential for a quality-build vehicle and an efficient assembly process. It would be further advantageous to provide a device and methods for use in a primary framing station to set the critical body geometry that provides increased access to the vehicle body which simplifies numerous sub-processes at the primary framing station which increases efficiency and increases the accuracy and precision of the entire build process for the vehicle.

### SUMMARY OF THE INVENTION

This invention generally relates to an improved vehicle body framing apparatus for an exemplary use of assembling and connecting sheet metal components of a vehicle body in a vehicle assembly plant.

A significant advantage of the present invention is the elimination of large, bulky side gate framing structures described above that were previously needed to support component tooling such as clamps, fixtures and other devices to hold loose or loosely connected components until they could be welded together or otherwise secured to one another.

The present invention, through the exemplary use of only four principal pillars and a bridge positioned over the vehicle body, allows significantly more open space along the sides of the vehicle body for access and movement of robots and other equipment used to establish the critical geometry of vehicle body skeletal structure. An additional advantage of the elimination of the side gate structures is simplifying and reducing the amount of equipment on the assembly plant floor and the amount of assembly facility floor space needed for the storage and movement of the many vehicle side gate structures which were previously needed as each pair of side gates.

In one aspect of the invention, a primary body framing and geometry station is equipped with a pair of base members positioned on the floor of an assembly plant adjacent to both sides of the assembly line. A pair of front vertical pillars and a pair or rear vertical pillars are positioned on the base members (four pillars total, two on each base member). At least one of the pairs of pillars, for example the front pillars, may move longitudinally along the base members to accommodate different lengths of vehicle bodies to be built. The movable pair of pillars are accurately and precisely positionable and lockable to the base members. The pillars provide both four-way and two-way locating devices for accurately and precisely locating the body in the geometry-setting station so the build processes can be made to extremely close tolerances for a quality build.

A preselected bridge structure is positioned and temporarily connected to the pillars forming an accurate and precise frame or gate structure to position tooling, fixtures, clamps and other devices to support the particular build operations. As an overhead or over-vehicle bridge/gate structure, substantially the entire sides of the vehicle body positioned between the pillars remain open and easily accessible for robots or human operators to access the desired areas. On a change of the vehicle body type to be build, the same bridge may be used, or alternately, the bridge can be removed from the pillars and a different bridge specific to the other body style can be positioned on the pillars and used in a similar manner as described.

In one aspect of the invention, the over-the-vehicle bridge is specific to the particular vehicle or body style. To accommodate the building of different body styles along one assembly line, an overhead bridge storage and transfer device is used to position the appropriate bridge over the vehicle body and lower that bridge onto the positioned pillars to assist in the proper position of the vehicle body during assembly. On the change of a vehicle body to be built, the overhead device raises the bridge from the pillars, transfers the bridge to a storage or holding area, and positions another bridge suitable for the vehicle body to be built at the framing station.

Other applications and variations of the present invention will become apparent to those skilled in the art when the following description contemplated for practicing the invention is read in conjunction with the accompanying drawings.

### BRIEF SUMMARY OF THE DRAWINGS

The description herein makes reference to the accompanying drawings wherein like reference numerals refer to like parts throughout the several views and wherein:

FIG. 1 is a perspective view of an example of the framer according to the invention;

FIG. 2 is a left side view of the inventive framer in FIG. 1 (showing the right hand side of the vehicle body);

FIG. 3 is a rearward end view of the inventive framer in FIG. 1;

FIG. 4 is a top view of the inventive framer in FIG. 1;

FIG. 5 is perspective view of an alternate example of a framer;

FIG. 6 is a perspective view of an example of a framer positioned at an exemplary build station or assembly cell including an enclosure positioned along an exemplary assembly line;

FIG. 7 is an enlarged perspective view of the alternate example of a framer shown in FIG. 6;

FIG. 8 is an end elevational view of the example of the framer shown in FIG. 7;

FIG. 9 is a perspective view of an example of a bridge transport and storage device;

FIG. 10 is an enlarged perspective view of a portion of the bridge transport shown in FIG. 9 in use with an example of a framer; and

FIG. 11 is a flow chart of an example of a method of use of the inventive framer described in FIGS. 1-10.

### DETAILED DESCRIPTION

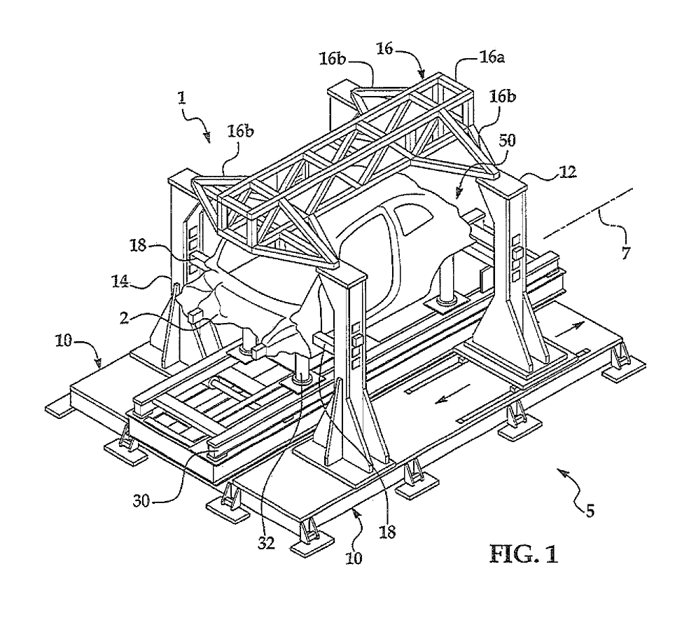

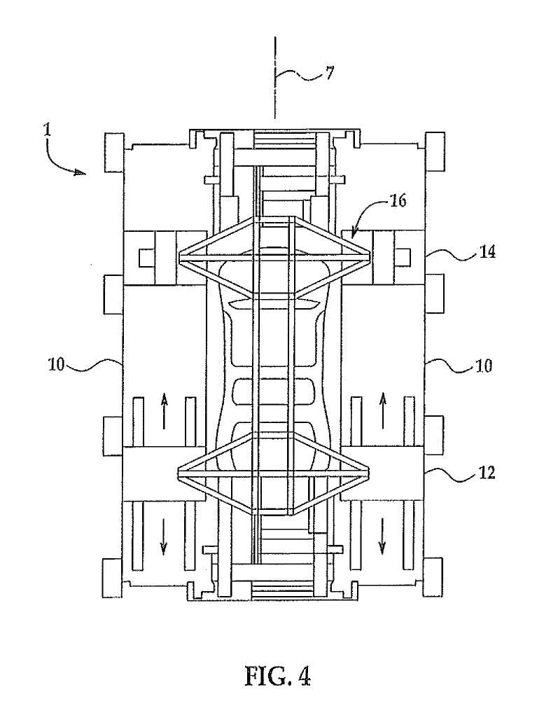

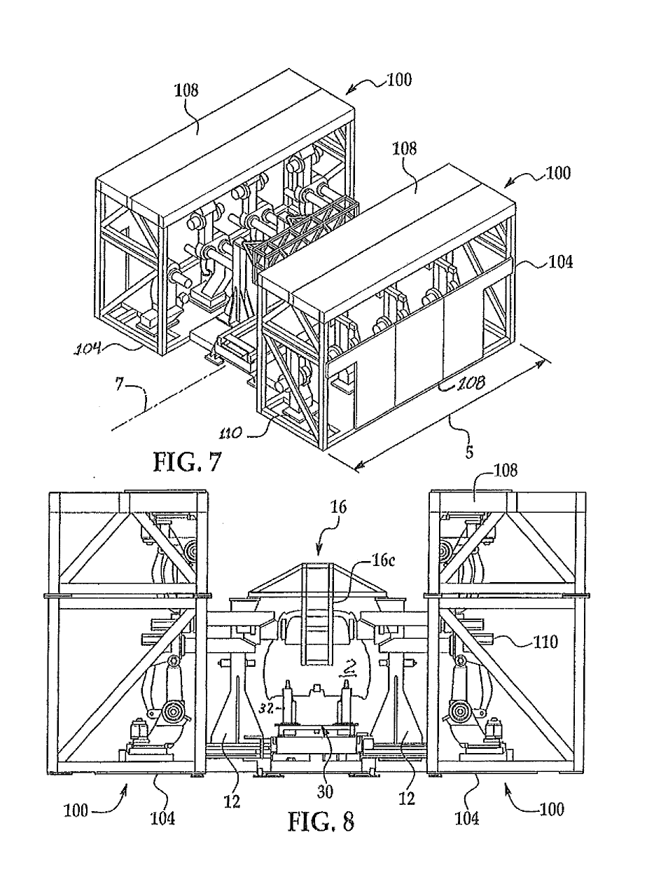

Examples of a variable vehicle body framer 1 in exemplary use at a body framing station 5 positioned along an assembly line 7 are shown in FIGS. 1-10. In an exemplary application, framer 1 is used to frame the body skeletal structure and establish the primary geometry of an automotive vehicle body 2. It is contemplated that other structures could be assembled using the present invention.

Referring to FIG. 1, in one example of framer 1, framer 1 includes parallel base members 10 suitably supported in spaced relation and mounted to a support surface, for example the floor of the motor vehicle assembly facility. A base, such as base members 10 can take many forms and serve to provide a structural support for the pillars, vehicle and bridge described below as well as human workers operating in the build station. For example, base 10 can be the assembly plant floor or other existing support structure suitable to support the pillars 12/14.

In the example shown, a pair of opposing rear or second pillars 12 extend substantially vertically from the respective base members 10. In the example shown, rear pillars are positioned toward the rear of the vehicle body. A pair of opposing front or first pillars 14 are similarly positioned on the respective base members 10 extending substantially vertically therefrom. In the example, the front pillars 14 are positioned toward the front of the vehicle body 2. The front pillars 14 and rear pillars 12 are longitudinally separated by a distance along the assembly line 7. Pillars 12 and 14 are preferably made from a high strength rigid material, for example iron, steel or aluminum, but may be manufactured from other materials, shapes, sizes and orientations as known by those skilled in the field. Although four pillars are shown and positioned generally at the corners of the vehicle 2, different numbers of pillars and placement respective of vehicle 2 known by those skilled in the field may be employed.

In the example, front pillars 14 are fixedly and rigidly secured to the respective base members 10 and rear pillars 12 are mounted for selective movement fore and aft on the base members in a direction parallel to the assembly line 7 to compensate for vehicle 2 body length variations. Although described and illustrated that the second or rear pillars 12 are movable relative to the base 10, it is understood that the first or front pillars 14 may be movable and with the rear pillars being fixed in position. It is further contemplated that both front and rear pillars may be movable relative to the base to suit the particular application and vehicle build.

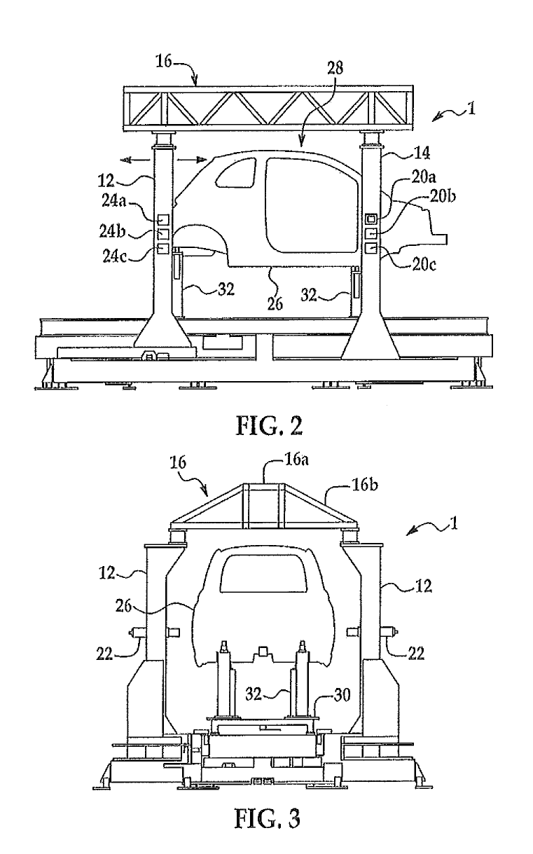

In the example shown in FIGS. 1 and 2, each front or first pillar 14 includes a four-way locator device 18 which, on engagement with the predetermined place on vehicle body 2, accurately and precisely locates the vehicle body 2 side structures with respect to the front pillars 14 in the x-direction (along assembly line 7) and the z-direction (vertical direction)). In one example, four-way locator device 18 is a model specific, electrically powered and servo-driven device. As described in more detail below, on satisfaction of automatic or manual safety checks verifying when bridge 16 is in place and vehicle 2 is properly positioned in build station 5, locators 18 on each pillar are actuating to engage the body and lock it in the predetermined position for further processing. As best seen in FIG. 2, four-way locators 18 may be positioned in several vertically spaced locations 20a, 20b, 20c on their respective pillar 14 to accommodate various motor vehicle models.

In the example shown in FIGS. 1, 2 and 3, each rear or second pair of pillars 12 includes a two-way vehicle locating device 22 which accurately and precisely locates the vehicle body side structures with respect to the pillars 12 in the z-direction. In one example, two-way locating device 22 includes a model specific, electrically powered and servo-driven device. As best seen in FIG. 2, similar to four-way locators 18, two-way locators 22 may be positioned in one of a plurality of vertically spaced locations 24a, 24b, 24c to accommodate various motor vehicle models. In one example, the vehicle 2 body side structures are located in the y-direction (transverse to assembly line 7) by a plug-type gage mounted on the bridge frame 16 and movable, automatically by a controller or actuator (not shown), by a robot, or through manual operation, to engage a selected portion of the vehicle body 2. In a typical, but not limited, use of pillars 12/14, the vehicle 2 body side subassemblies are located and fixtured on the pillars 12/14 for use in connecting to the skeletal underbody and other components to be assembled in the framer 1. It is understood that such locators 18 and 22 may be positioned and articulated in other areas and directions on their respective pillar 12/14 without deviating from the present invention.

In the example shown in FIGS. 1-4, framer 1 includes a bridge framing structure 16. In the example shown, bridge 16 has a skeletal or truss-like configuration including a main body section 16a generally extending in a longitudinal direction along assembly line 7. Exemplary bridge 16 further includes mounts 16b (four shown) extending laterally outward from main body 16a each for supporting an accurate engagement with a respective pillar 12 or 14. As generally shown, bridge 16 is designed to be a strong and rigid structure and in combination with the rigid and accurately positioned pillars 12/14, provides a rigid and accurate connection point for tooling, fixtures, clamps and other devices used to carry out the skeletal geometry-setting operations and processes on the upper and central portions of the vehicle. For example, bridge 16 may be used to fixture, move into the desired position in the x, y and z directions with respect to the pillars 12/14, and through other equipment, for example robotic spot welders, connect cross-vehicle components such as the dash panel, cowl panel, back panel and package tray as well as other components between the body side structures held and positioned by the pillars 12/14. Bridge 16 may further be used to locationally position the vehicle 2 body side panel assemblies which are initially connected and held into a desired position to the pillars 12/14 to assist in positively locating the side panels in the desired x, y and z locations.

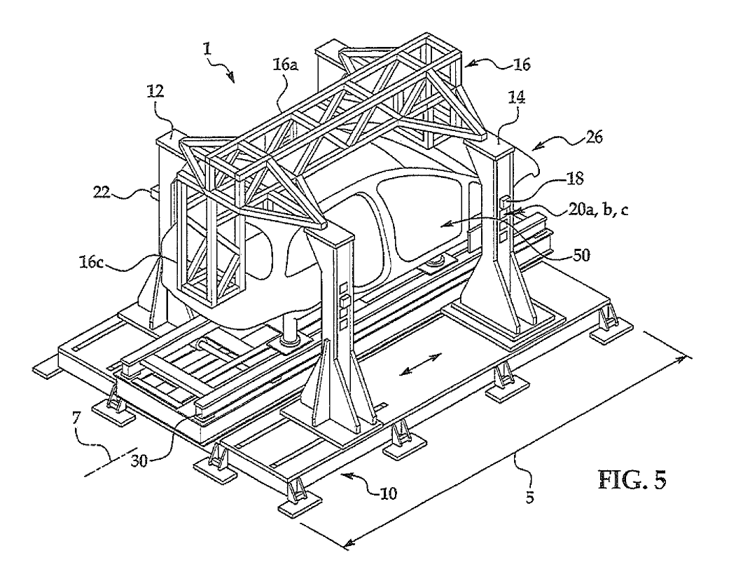

Bridge 16 may be made from materials similar to pillars 12/14, for example steel or aluminum, but other materials as well alternate shapes, sizes, configurations and orientations known by those skilled in the art may be used. For example as shown in FIG. 5, an alternate bridge 16 including a downstanding portion 16c to accommodate an alternate vehicle body 2 is shown. In this example, the underbody of skeletal frame of vehicle 2 is set in the x, y and z directions by the single geometry pallet 30 described further below. The pallet 30 is then positionally registered with the framer 1.

In one example, the vertically extending or distal ends of the pillars 12/14 include receivers (not shown) to receive and locationally position or register pin locators or other members (not shown) connected to the bridge 16 and extending downwardly toward the pillars to temporarily locate and secure the bridge 16 to the pillars 12/14. The pillar receivers and bridge locating pins can take many forms known by those skilled in the art. For example, each receiver on a pillar may include several positioning blocks or bushings to guide and seat the coordinating pin on the bridge in the desired location to accurately position the bridge 16 with respect to the pillars. In an alternate example, the described receivers could be located on the bridge and locator pins on the pillars. Other locating devices and methods for positioning and securing the bridge to the pillars known by those skilled in the art may be used.

In one example shown in FIGS. 1-4, each bridge 16 is vehicle body 2 model specific and is lowered into position relative to the top of the pillars 12/14 using the locating pins and receivers generally described above. With the exemplary rear pillars 12 able to longitudinally move relative to base members 10, different body 2 length vehicles can be assembled at the same build station 5 without significant transition or substitution of major assembly equipment already positioned at the station. For example, a relatively short bridge 16 would be utilized with the rear pillars 12 in a relatively forward position (to the right in FIG. 2) to accommodate a relatively short vehicle 2 and a relatively long bridge 16 would be utilized with the rear pillars 12 in a relatively rearward position (to the left in FIG. 2) to accommodate a relatively long vehicle.

As best seen in FIGS. 1 and 5, between front or first pillar 14, rear or second pillar 12 and bridge 16, a large body access area 50 is formed. Access area 50 provides a significant space between the framer 1 structures to access the vehicle body, for example, to weld components and carry out other assembly operations known by those skilled in the art.

As generally shown in FIGS. 1-8, vehicle body 2 is positioned on and transported by a movable pallet 30 including pillars 32 (four shown) mounted on the pallet 30 having locating pins (not shown) which engage predetermined locations on the body. One example of a suitable pallet 30 is a Single Geometry Palletized Framing System included in U.S. patent application Ser. No. 12/257,922 assigned to assignee of the present invention and incorporated herein by reference. Pallet 30 is transported on carriage or roller bed-type structure 31 having wheels or rollers and is selectively moved along assembly line 7. Examples of transporting the pallet 30 and carriage 31 may include, for example, a powered roller system onboard the pallet 30 or carriage 31 which is controlled by a preprogrammed controller (not shown) and guided by rails (not shown) positioned along assembly line 7. Alternate pallet system direction and guidance systems may include encoded strips or bars (not shown) mounted on the pallet 30 which pass through readers (not shown) in a closed-loop system to actively and positively drive and position the pallet and accompanying vehicle body along the assembly line through sequential build stations, for example build station 5. An example of the encoded strip is disclosed in U.S. Pat. No. 7,108,189 assigned to the assignee of the present invention and incorporated herein by reference. Other devices and methods for moving and positioning a pallet 30 and supported vehicle body 2 include a powered pallet 30 without use of guide rails, but rather guided by receipt of signals from a remote controller which powers and guides the pallet 30 along a predetermined path along assembly line 30. This can be accomplished by use of an onboard controller or through docking of an automated guided vehicle (AGV) (not shown) which docks with the pallet 30 and drives and guides the pallet and vehicle body 2 along the assembly line 2. An example of such a system is disclosed in U.S. patent application Ser. No. 12/913,908 assigned to the assignee of the present invention and the contents of which are incorporated herein by reference. Other pallet 30 transport systems, for example connection of the pallet 30 to a powered chain or cable drive in the floor of an assembly plant, known by those skilled in the art may be used.

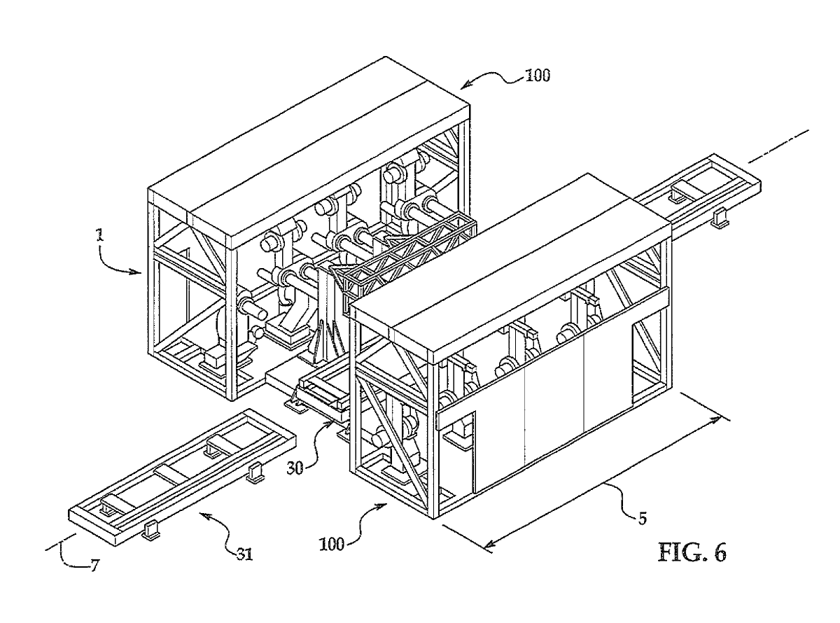

Referring to FIGS. 6, 7 and 8, an alternate example of framer 1 is shown. In the example, a structure 100 is positioned adjacent each side of framing station 5 along assembly line 7. Structure 100 may include a frame or leg 104 and a plurality of panels 108 connected to the frame surrounding a plurality of manufacturing and assembly equipment, for example robots 110, positioned both on the floor and suspended from the frame, are used to build the vehicle body using the framer 1 described above. As shown in FIG. 6, the high density welding framing station 5 is compact and requires little or no other side framing gates, gate positioning stations or conveyors for moving the prior side gate structures to and from the framing station 5. The open access to the body 2 provided by the framer 1 works particularly well with the high density welding station 100 and allows maximum use of robots and other high volume assembly equipment to increase production efficiency and volume. Additional details of the high density welding station 100 is disclosed in U.S. patent application Ser. No. 12/262,722 assigned to the assignee of the present invention and is incorporated herein by reference. This simplifies the manufacturing and assembly floor and provides additional and/or simplified assembly stations upstream and downstream from framing station 5 along assembly line 7.

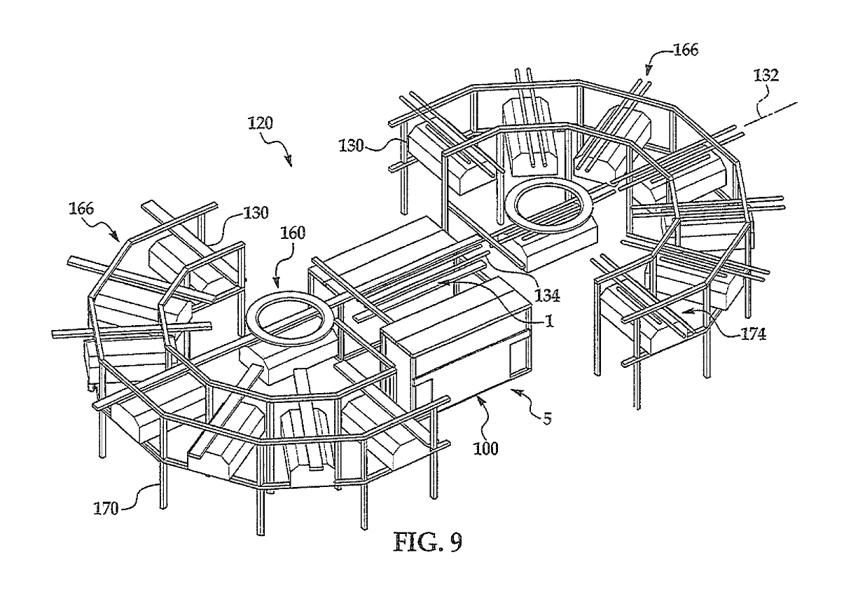

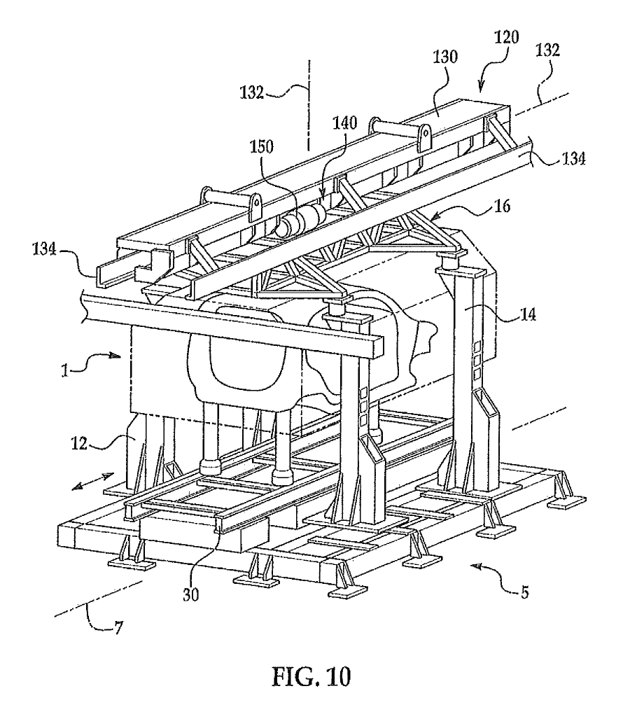

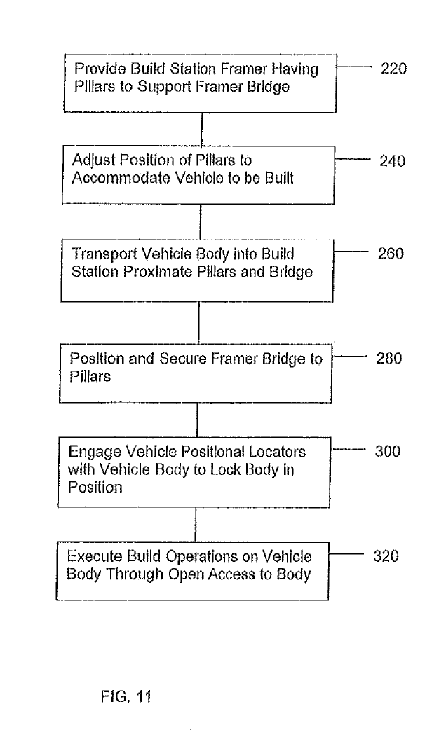

Referring to FIGS. 9 and 10, an example of a bridge 16 transport and storage device and method 120 is shown. Bridge transport device 120 is shown in exemplary use at a framing station 5 including framer 1. As disclosed above, framer 1 preferably utilizes a bridge 16 which is unique to a particular vehicle body to be built. When multiple body styles are to be built along the same assembly line 7, a means to change, transport and store the various bridges 16 is needed.

As best seen in the example shown in FIGS. 9 and 10, bridge transport and storage device 120 includes elongate rails 134 which are suspended from the assembly plant ceiling or other floor-mounted support structure 170. Rails 134 extend in a substantially linear path parallel to axis 132 between a storage area 166 (two shown) distant from framing station 5. The storage areas 166 include a plurality of bays 174 which are sized to accommodate at least one bridge 16 that is not in use at framing station 5. Between framing station 5 and storage areas 166 a turret 160 is positioned in communication with rails 134 and axis 132. In the example shown, storage device 120 includes several bridge transfer cartridges 130, one cartridge 130 for each of the framing station 5, turret 160 and storage bay 174. Each cartridge 130 is generally supported by rails 134 or other structure. In one example, transfer cartridge 130 includes powered rollers from which a respective bridge 16 engages and is selectively moved along a path of travel as determined by a preprogrammed controller (not shown). An example of an overhead transport and conveying system generally suitable for use in conveying bridges 16 is the VersaRoll brand system marketed and sold by Comau, Inc, assignee of the present invention, disclosed in U.S. Pat. No. 6,799,673 and is incorporated herein by reference.

As an example, at framing station 5 shown in FIG. 10, the transfer cartridge 130 cooperates with an elevator device 140 used to selectively engage/disengage, raise and/or lower the bridge 16 along axis 132. In one example, elevator 140 includes an electric motor 150 or winch with one or more steel cables (not shown) which connect to the bridge 16 through a hook or other connecting apparatus known to those skilled in the art. In an alternate example, the transfer cartridge 130 is raised or lowered along axis 132 to position the bridge 16 on pillars 12/14 as generally described.

As an example, turrets 160 cooperate with the transfer cartridge 130 and the engaged bridge 16 to permit rotation or other translation of the bridge 16 to be angularly oriented toward the selected bay 174. The bridge 16 is then linearly transferred to the selected bay for temporary storage until needed to build the particular vehicle body suitable for the bridge. The frame 170 and bays 174 include suitable rails and other support structure (not shown) for an automated and smooth transition of the carrier and bridge 16 from the rails 134 positioned along axis 132 and framing station 5 and framer 1.

The bridge transport and storage device 120 is useful to quickly change bridges 16 needed at framer station 5 to build alternate vehicle bodies to accommodate flexible production of different vehicles body types or styles. The device 120 further provides the advantages of framer station 5 above by simplifying the structure and equipment as well as assembly plant floor space over previous designs. Although several examples have been described and illustrated, other devices, components, configurations and orientations may be used as known by those skilled in the art.

In a method of operation, a geometry framing station or assembly cell 5, and preferably a plurality of stations or cells 5 positioned along an assembly line 7 is established in an assembly area or plant. At a particular build station 5, a predetermined vehicle body style 2 is designated, typically through establishment of a daily or shift build schedule at the assembly plant.

In a preferred method step 220, the build station 5 provides or includes in a step 200 framer 1 having base members 10 with pillars 12 and 14 in position on opposing sides of the assembly line 7. The appropriate bridge 16 to build the predetermined vehicle body 2 is identified. A bridge transport system 120 is activated and carrier 130 engages the selected bridge 16 for transport to the build station 5 and framer 1.

In step 240, adjustable position rear or second pillars 12 are moved relative to base members 10 to accommodate the length of the vehicle 2 to be built next.

In step 260, vehicle body 2, in either a beginning, intermediate or close to final state of the progressive build of the vehicle body 2, is transported along assembly line 7 into the build station proximate the pillars 12/14 and bridge 16.

In step 280, the bridge 16 is positioned in build station 5 and lowered down onto and engages pillars 12 and 14 thereby placing the tooling, fixtures and other equipment accurately and precisely with respect to the pillars and build station 5.

On close positioning of vehicle 2 to the desired predetermined location, in step 300 positional locators 18 and 22 are articulated to engage predetermined points on the vehicle body 2 to further adjust, if necessary, the positional location of the vehicle body to the predetermined or design position at build station 5 to very close tolerances to ensure the various build operations are as accurate and precise as possible. In an exemplary process, the vehicle 2 underbody structure is located and positioned on pallet 30, the vehicle body side assemblies are fixtured and located in position by the pillars 12/14. In one example, cross-vehicle and other skeletal components are pre-positioned in their respective general locations in vehicle 2 upstream along the assembly line 7 before pallet 30 is moved into framing station 5. Once the bridge 16 is installed on pillars 12/14, such components are fixtured and locationally positioned by the bridge 16 through sub-fixtures, clamps and other holding and positioning equipment connected and extending therefrom (not shown) thereby accurately and precisely connecting such components and establishing the desired geometry for the progressively built vehicle 2 while achieving all of the benefits and advantages of the invention described herein.

In step 320, through the large and open access to the vehicle body 2 afforded by framer 1, the build or assembly operations can be carried out to further position and connect the skeletal components, through for example spot welding, on the vehicle body 2 to rigidly connect such components and establish the vehicle body geometry in a highly efficient and expeditious manner. Additional steps not mentioned, as well as the reordering of the above-described steps, may be used as known by those skilled in the art.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A vehicle body framer for use in assembling and establishing the primary geometry of a vehicular body at a geometry framing station positioned along an assembly line, the framer comprising:
a base positioned at the framing station along an assembly line path;
a first pair of elongate pillars extending upward from the base, each pillar having a first end fixedly connected to the base and a distal second end;
a second pair of elongate pillars extending upward from the base and positioned distant from the first pillars along the assembly path, each second pillar having a first end selectively moveable relative to the base and first pair along the assembly path and a distal second end;
a bridge frame selectively and removably connected proximate the distal ends of the first and the second pairs of pillars, the pillars operable to locationally position the bridge frame in a predetermined location; and
a vehicle body locator connected to each of at least one of the first and the second pillars, each locator adapted to engage the vehicle body and locationally position the vehicle body relative to the respective pillar.

2. The vehicle framer of claim 1 wherein each pillar includes a body locator, each locator laterally extendible to engage a predetermined area of the vehicle body.

3. The vehicle framer of claim 2 further comprising:
a vehicle body position sensor for detecting the location of the vehicle body in the framing station;
an actuating mechanism connected to the body locators; and
a controller in electronic communication with the position sensor and actuating mechanism, the controller operative to move at least one of the locators to engage the vehicle body on receipt of a signal from the position sensor that the vehicle body is properly positioned in framer and ready for engagement by the at least one locator.

4. The vehicle framer of claim 2 wherein each locator is adjustable in a vertical direction along the respective pillar to adjust for variances in height of the predetermined engagement area on different vehicle bodies.

5. The vehicle framer of claim 2 wherein the body locator further comprises a plurality of individual body locators positioned on each respective pillar separated in a vertical direction along the respective pillar to accommodate variances in height of the predetermined engagement area on different vehicle bodies.

6. The vehicle framer of claim 1 wherein the bridge comprises a plurality of individual bridge frames, each bridge frame including a geometry that is specific to a different vehicle body.

7. The vehicle framer of claim 1 wherein substantially all of the bridge frame is positioned vertically above the vehicle body positioned in the framing station, the bridge and the respective first and second pillars defining a vehicle body side access opening between the bridge and the respective pillars.

8. The vehicle framer of claim 7 wherein the body side access opening is free from obstructions and adapted to provide free and open access to the vehicle body side for assembly and joining operations at the geometry-setting station.

9. The vehicle framer of claim 1 further comprising a bridge frame transport system for selective transport and connection of a plurality of individual and different bridge frames to the first and second pillars, each individual bridge frame suitable for a different selected vehicle body to be built at the framing station.

10. The vehicle framer of claim 9 wherein the bridge frame transport further comprises:
a bridge storage device positioned in communication with the framing station;
a bridge carrier positioned between and connected to the bridge storage device and framing station, the carrier adapted to selectively engage and disengage a selected bridge frame and transport the bridge between the storage device and the framing station; and
a bridge elevator, the bridge elevator operable to vertically raise and lower a selected bridge to and from the first and the second pillars.

11. The vehicle frame of claim 1 further comprising a vehicle body transport, the vehicle body transport comprising:
a vehicle body pallet adapted to engage and positionally support at least a portion of a vehicle body in the process of being assembled;
a powered pallet transport engagable with the pallet, the transport adapted for selectively moving the pallet along the assembly line to position the pallet and vehicle body in a predetermined position adjacent the respective first and the second pillars.

12. A method for assembling vehicle body components along a vehicle body assembly line path, the method comprising the steps of:
positioning a first pair of upstanding pillars and a second pair of upstanding pillars in a body framing station, the second set of pillars positioned distant from the first pillars along an assembly line path, each respective pillar of each pair positioned on opposing sides of the assembly line;
positioning and removably connecting a bridge frame to the first and the second pillars to locationally position the bridge relative to the pillars to accommodate the particular vehicle to be built;
positioning at least a portion of a vehicle body at least partially between the first pillars and the second pillars in the body framing station; and
selectively engaging at least one pillar from each of the first and the second pillars with the vehicle body to locationally position the vehicle body relative to the pillars and the bridge.

13. The method of claim 12 further comprising the step of:
selectively moving one of the first and the second pairs of pillars relative to the other pair in a direction along the assembly line to accommodate different lengths of different vehicle body types to be assembled at the framing station;

14. The method of claim 12 wherein the step of selectively engaging the at least one pillar with the vehicle body further comprises the step of:
laterally engaging a body side locator connected to each pillar with a predetermined area of the vehicle body positioned in the framing station.

15. The method of claim 14 wherein the step of laterally engaging the body further comprises the step of:
selecting from one of a plurality of body side locators positioned vertically apart from one another on each respective pillar prior to engaging the locator with the vehicle body, the plurality of vertically separated locators used for accommodating the different vehicle bodies having predetermined area heights.

16. The method of claim 14 wherein the step of laterally engaging the body further comprises the step of:
vertically adjusting the position of each locator relative to the respective pillar to accommodate a different vertical position of the predetermined area on different vehicle bodies to be assembled in the framing station.

17. The method of claim 12 wherein the step of connecting a bridge frame further comprises the step of connecting one of a plurality of separate and individual bridge frames of different geometry, each bridge suitable for a different vehicle body type.

18. The method of claim 17 further comprising the step of:
transporting the selected one of a plurality of bridges between the framing station and a bridge frame storage area for temporary storage of bridge frames when not in use.

19. The method of claim 12 further comprising the step of creating a vehicle body side access opening between the respective first pillars, the second pillars and the connected bridge along an assembly line, each respective body side access opening allowing substantially open, continuous and unobstructed access to the adjacent vehicle body between the respective pillars and bridge.

20. A vehicle body framer for use in assembling a vehicular body at a framing station positioned along an assembly line, the framer comprising:
means for positioning a first pair of upstanding pillars and a second pair of upstanding pillars in a body framing station, the second set of pillars positioned distant from the first pillars along an assembly line path, each respective pillar of each pair positioned on opposing sides of the assembly line;
means for positioning and removably connecting a bridge frame to the first and the second pillars to locationally position the pillars and the bridge relative to one another to accommodate the particular vehicle to be built;
means for positioning at least a portion of a vehicle body at least partially between the first pillars and the second pillars in the body framing station; and
means for selectively engaging at least one pillar from each of the first and the second pillars with the vehicle body to locationally position the vehicle body relative to the pillars and the bridge.
